(19) United States
(12) Patent Application Publication
(10) Pub. No.: US 2007/0050508 A1
(43) Pub. Date: Mar. 1, 2007

(54) Method and apparatus for management and interaction of a subscriber identification of a wireless terminal

(75) Inventor: Mingjun Shan, Shenzhen (CN)

Correspondence Address: MERCHANT & GOULD PC, P.O. BOX 2903, MINNEAPOLIS, MN, 55402-0903, US

(73) Assignee: Huawei Technologies Co., Ltd., Shenzhen (CN)

(21) Appl. No.: 11/493,874

(22) Filed: Jul. 26, 2006

(30) Foreign Application Priority Data
Jul. 29, 2005 (CN) 200510088752.9

(51) Int. Cl. G06F 15/16

(52) U.S. Cl. 709/227

(57) ABSTRACT

The present invention provides a method and apparatus for the management and interaction of a subscriber identification of a wireless terminal, which are applied in a service based on the Session Initiation Protocol (SIP). The method includes: storing the Session Initiation Protocol Universal Resource Indicator of the wireless terminal in a wireless electronic card as the content of the card; and the Session Initiation Protocol Universal Resource Indicator interacting between wireless terminals or between the wireless terminal and the network side in the form of a wireless electronic card. The present invention solves the problem in the prior art that the storage modes of the SIP URI used by the wireless terminal in the service based on the SIP are not uniform and are not convenient for the exchange of the SIP URI information between the terminals.

### FIELD OF THE INVENTION

The present invention relates to the wireless communication field, and more particularly to a method and apparatus for management and interaction of a subscriber identification of a wireless terminal.

### BACKGROUND OF THE INVENTION

Session Initiation Protocol (SIP) was proposed by the Internet Engineering Task Force (IETF) in 1999, which is used to realize real-time communication based on IP network, especially based on the Internet.

SIP has developed from various text applications to supporting the multimedia communication and will become the core control protocol in the next generation network (NGN). The reason the 3rd Generation Partnership Project (3GPP) adopts SIP to support voice and data is that by providing necessary protocol mechanisms, SIP can guarantee the realization of functions such as the subscriber orientation, subscriber capacity, subscriber availability, call establishment, call processing, call forwarding and number transferring between the terminal system and the agent server.

Currently, SIP has become the most important application protocol in the mobile network, Internet and NGN, etc. In the wireless network, the services based on SIP mainly include the Push to Talk Over Cellular (POC) service, the Presence service based on Simple, and IP phone service.

In the services based on the SIP, the subscriber identification between two parties or among more parties may be SIP Universal Resource Indicator (URI), and the basic format of the SIP URI may be as follows:

URL;TYPE=POC: sip:tom@poc1.com

It is to be noted that tom@poc1.com is similar to the email address, which is identified by the suffix domain name and is unique worldwide.

In the related art, the SIP URI of the subscriber is generally stored dispersedly and without a uniform storing position. For example, in the POC service and/or SIMPLE/IM service, the SIP URI is stored in the client software.

The client software can be operated in the wireless terminal through embedding mode or downloading mode. The embedding mode means that the user can only write the client software in the client terminal for one time and the final subscriber cannot uninstall or reinstall the software. The downloading mode means that the user can download and install the client software in the terminal for many times. In the development trend of the future services, the download mode will gradually become the mainstream application due to the characteristics of the flexibility and easy update of the downloadable client software.

Since the SIP URI doesn't have a uniform storing method, if the SIP is only stored in the client software, the SIP URI is prone to be lost when the subscriber updates the software. In addition, when several services based on SIP coexist, the storage and management of the SIP URI is complicated. For example, the SIP-URI of the POC service and that of the SIMPLE/PRECENSE service are respectively stored and managed. However, when the POC service and the SIMPLE/PRECENSE service use the same SIP-URI, it is not convenient for the share of the identification. Moreover, since the wireless terminals from different manufacturers lack the uniform interaction mechanism, the wireless terminals based on the SIP cannot exchange the personal SIP URI conveniently, which influence the communication efficiency between any two of the terminals.

### SUMMARY OF THE INVENTION

A method applied in a service based on the Session Initiation Protocol includes the steps of: a management step, in which the Session Initiation Protocol Universal Resource Indicator of the wireless terminal is stored in the format of a wireless electronic card in a wireless electronic card list; and an interaction step, in which the Session Initiation Protocol Universal Resource Indicator interacts between wireless terminals or between the wireless terminal and the network side in the form of a wireless electronic card.

An apparatus for the management and the interaction of a subscriber identification of a wireless terminal, which is applied in a service based on the Session Initiation Protocol, includes a wireless electronic card function module and a card generating module. The wireless electronic card function module maintains a local wireless electronic card list and realizes the exchange of the wireless electronic card with other wireless terminal or with a network side.

The card generating module is connected with the wireless electronic card function module and stores the Session Initiation Protocol Universal Resource Indicator in the format of the wireless electronic card in the wireless electronic card list of the wireless electronic card function module.

### BRIEF DESCRIPTION OF THE DRAWINGS

FIG. 1 is a flow chart showing the process of transmitting a wireless electronic card between wireless terminals;

FIG. 2 is a flow chart showing the process of obtaining a wireless electronic card by the subscriber from the network side according to an embodiment of the present invention;

FIG. 3 is a schematic diagram showing the architecture of the apparatus for the management and the interaction of the subscriber identification of the wireless terminal according to an embodiment of the present invention.

### DETAILED DESCRIPTION OF THE INVENTION

The present invention will be illustrated in detail with reference to the drawings and embodiments.

A preferred embodiment of the present invention realizes the management, backup and exchange of the SIP URI between subscribers with the help of the current vCard exchanging technology.

Firstly, the SIP URI is stored according to the vCard format in the local vCard.

The format of the vCard in the related art is as follows:

PropertyName [; PropertyParameters]: PropertyValue

The PropertyName is the property name of the vCard, the PropertyParameters is its parameter and the ProperValue is its property value.

For example, the PropertyName “TEL” represents a phone, the PropertyParameters “HOME” means the phone is a home phone and the ProperValue “+1-919-555-1234” represents the phone number.

The SIP URI information is stored in the vCard through the following steps:

(1) Setting the property name of the vCard which stores the SIP URI.

A new property name is added to represent the SIP URI and is represented as, for example, SIP_URI as well as other symbols as long as they are different from the normal electronic card.

In the present invention, the relation between the wireless terminal and the SIP URI may be one-to-one or one-to-many correspondence. The wireless terminal may only have one SIP URI and all the SIP services registered by the wireless terminal use the same SIP URI; or the wireless terminal may have several SIP URIs and each SIP service registered by the wireless terminal uses a different SIP URI; or the wireless terminal may have several SIP URIs. Some SIP services registered by the wireless terminal use different SIP URIs and some SIP services use the same SIP URI.

(2) Storing the SIP service identification as a vCard parameter.

Different parameters can be adopted according to different SIP services.

For example, SIMPLE can be the service identification of the Simple service and can be stored in the vCard corresponding to the service as a vCard parameter.

POC can be the service identification of the POC service and can be stored in the vCard corresponding to the service as a vCard parameter.

IPPHONE can be the service identification of the IPPHONE service and can be stored in the vCard corresponding to the service as a vCard parameter.

(3) Storing the SIP URI information corresponding to the SIP service as the vCard property value.

For example: the SIP URI information corresponding to a SIP service is:

URL; TYPE=POC: sip:tom@poc1.com

According to the vCard storing format, the URL; TYPE=POC: sip:tom@poc1.com is stored in the PropertyValue part of the vCard corresponding to the SIP service.

For example: the normal form of VCARD is:

BEGIN: VCARD

PropertyName [‘;’ PropertyParameters] ‘:’ PropertyValue

END: VCARD When the SIP URI is the Objec of the vCard, the exemplary storing formats of different fields are:

PropertyName is SIP_URI

PropertyParameters is POC

PropertyValue is sip:tom@poc1.com

The exemplary complete SIP URI stored in the vCard is as follows:

The exemplary SIP URI stored in the vCard is:

BEGIN: VCARD

SIP_URI;PoC: sip:tom@poc1.com

. . .

END: VCARD

If a wireless terminal only registers one SIP service, one SIP URI record corresponding to the registered service is to be stored in the local vCard list. If the wireless terminal registers several SIP services at the same time, the SIP URI records each of which is one-to-one corresponding to a registered service are to be stored in the local vCard list.

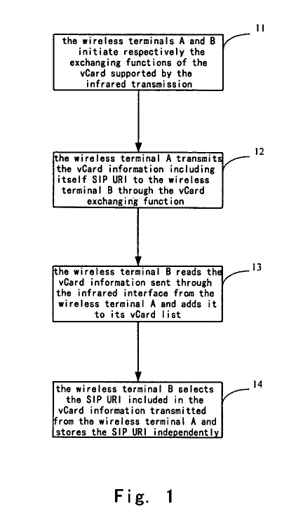

After storing the SIP URI in the local vCard list, the wireless terminal can transmit it to other wireless terminal or to the network side with the help of the vCard exchanging technology. As FIG. 1 shows, assuming the wireless terminals A and B both support the infrared transmission vCard, the process that the wireless terminal A transmits the locally stored SIP URI to the wireless terminal B is as follows:

Step 11, the wireless terminals A and B initiate respectively the exchanging function of the vCard supported by the infrared transmission.

Step 12, the wireless terminal A transmits the information in the vCard list including the SIP URI of itself to the wireless terminal B through the infrared interface by using the vCard exchanging function.

Or the wireless terminal A transmits its SIP URI stored in the vCard list as one piece of vCard information to the wireless terminal B through the infrared interface by using the vCard exchanging function.

Step 13, the wireless terminal B reads the vCard information sent from the wireless terminal A through the infrared interface and adds the information to its vCard list.

Step 14, the wireless terminal B selects the SIP URI included in the vCard information transmitted from the wireless terminal A and stores the SIP URI independently.

The detailed selection of the SIP URI in the step 14 includes: searching for the vCard whose property name is the designated SIP URI identification, for example, searching for the vCard with the property name of SIP_URI and then selecting the property value of the vCard and storing it.

In addition, the whole vCard information whose property name is the designated SIP URI identification can be stored directly; or the vCard parameter and its property value selected from the vCard can be stored together; or when storing the property values, the services corresponding to the property values can be identified for the wireless terminal which registers several services.

The wireless terminal B stores the selected SIP URI independently so that when it initiates a SIP service call to the wireless terminal A, it can smoothly find the SIP URI corresponding to the wireless terminal A.

For example, when the wireless terminal B reads the Presence information of the wireless terminal A, the wireless terminal B selects the SIP URI corresponding to the Presence service of the wireless terminal A from the independently stored SIP URIs. For example, the wireless terminal B may select the property value corresponding to “SIMPLE”, and then sends a request to the network side, which includes the selected property value as a SIP URI. The related function server at the network side authenticates the validity of the SIP URI and then sends the Present information of the wireless terminal A to the wireless terminal B.

If the wireless terminal B doesn't store the SIP URI from the wireless terminal A independently, when it initiates a SIP service call to the wireless terminal A, it needs to search for the SIP URI corresponding to the wireless terminal A in the locally stored vCard information.

Similarly, the wireless terminal B can send its own SIP URI to the wireless terminal A through the above flow process.

The above transmission of the vCard information between the wireless terminals is not limited to the infrared transmission, which can also be the blue-tooth transmission or the wireless phone network transmission.

In addition, the wireless terminal in the present invention can transmit the locally stored vCard list including the SIP URI to the network side which stores the vCard list. Taking the mobile phone supporting the GPRS as an example of the wireless terminal, the wireless terminal first initiates a vCard backup service, then reads out the information in the local vCard list through GPRS and transmits the information to the network side through carrier of syncML (synchronization mark language).

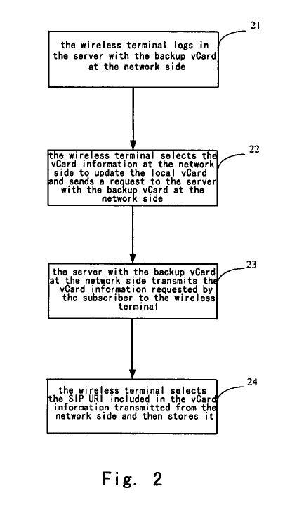

Thus, if the wireless terminal loses the stored electronic card list or the SIP URIs of other wireless terminals, or when the subscriber needs to change the wireless terminal, the backup vCard list information stored at the network side before can be downloaded to the local terminal and the information in the wireless terminal can be recovered. Please refer to FIG. 2 for the specific process, which includes:

Step 21, the wireless terminal logs in the server with the backup vCard at the network side.

Step 22, the wireless terminal selects the vCard information at the network side to update the local vCard and sends a request to the server with the backup vCard at the network side.

The requested vCard information can be the local vCard list information formerly backupped at the network side by the subscriber; and also can be the vCard list information backupped at the network side by the other wireless terminal subscribers as long as the subscriber has the corresponding download right.

Step 23, the server with the backup vCard at the network side transmits the vCard information requested by the subscriber to the wireless terminal.

Step 24, the wireless terminal selects the SIP URI included in the vCard information transmitted from the network side and then stores it. The specific selection and management methods are the same with those in step 14.

The present invention also provides an apparatus for the management and the interaction of the subscriber identifications of the wireless terminals according to the aforementioned method.

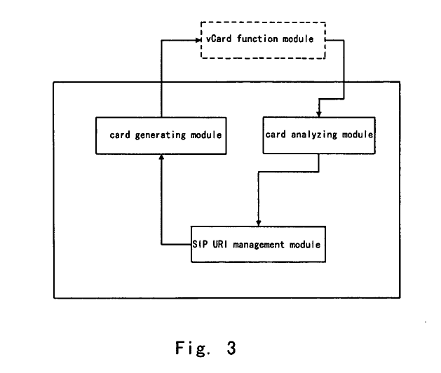

The architecture of the apparatus in the preferred embodiment is shown in FIG. 3. The apparatus includes a vCard function module, a card generating module, a card analyzing module and a SIP URI management module. The card analyzing module, the SIP URI management module and the card generating module are connected successively. The card generating module and the card analyzing module are connected with the vCard function module respectively.

The vCard function module is the one in the wireless terminal that supports and realizes the vCard function, and is mainly used to maintain the vCard list and realize the exchange of the vCard information with other wireless terminal or with the network side.

The card generating module unifies the SIP URI of the local or other wireless terminal obtained from the SIP URI management module into the vCard format and stores them in the vCard function module.

The card analyzing module finds the vCard including the SIP URI from the vCard information of other wireless terminal or from the network side received by the vCard function module and selects the SIP URI and stores it in the SIP URI management module.

The SIP URI management module stores the SIP URI.

The present invention can be realized in different networks such as the GPRS, WCDMA, CDMA2000 or TD-SCDMA, and the transmission includes but is not limited to the data transmission in the packet domain or the circuit domain.

In addition, the method and apparatus of the present invention are not limited to the vCard technology. For example, the DevInfo of OMA can unify the SIP URI into the DevInfo format and the interactions of SIP URI information between the terminals and between the terminal and the network side can be realized by the DevInfo technology. The detailed method flow and apparatus architecture are similar to those by the vCard solution.

Though illustration and description of the present invention have been given with reference to preferred embodiments thereof, it should be appreciated by ordinary personnel skilled in the art that various changes in forms and details can be made without deviation from the spirit and scope of this invention as defined by the appended claims.

1. A method for management and interaction of a subscriber identification of a wireless terminal, which is applied in a service based on the Session Initiation Protocol, comprising the steps of:
a management step for storing the Session Initiation Protocol Universal Resource Indicator of the wireless terminal in the format of a wireless electronic card in a wireless electronic card list; and
an interaction step, in which the Session Initiation Protocol Universal Resource Indicator interacts between wireless terminals or between the wireless terminal and the network side in the format of a wireless electronic card.

2. The method for management and interaction of a subscriber identification of a wireless terminal according to claim 1, wherein,
the management step further comprises: storing the Session Initiation Protocol Universal Resource Indicator and an service identification of a service corresponding to the Session Initiation Protocol Universal Resource Indicator in the same wireless electronic card.

3. The method for management and interaction of a subscriber identification of a wireless terminal according to claim 2, wherein,
the management step further comprises: identifying the wireless electronic card containing the Session Initiation Protocol Universal Resource Indicator according to a predetermined identification.

4. The method for management and interaction of a subscriber identification of a wireless terminal according to claim 1, wherein,
the management step further comprises: identifying the wireless electronic card containing the Session Initiation Protocol Universal Resource Indicator according to a predetermined identification.

5. The method for management and interaction of a subscriber identification of a wireless terminal according to claim 1, wherein,
the wireless electronic card is a local standard defined electronic card and interacts according to the exchange technology of the local standard defined electronic card.

6. The method for management and interaction of a subscriber identification of a wireless terminal according to claim 1, wherein,
the wireless electronic card is DevInfo and interacts according to the exchange technology of the DevInfo.

7. The method for management and interaction of a subscriber identification of a wireless terminal according to claim 1, wherein, the wireless electronic card is a local standard defined electronic card; and
the management step comprises:
storing a designated identification which represents that the stored information is the Session Initiation Protocol Universal Resource Indicator as the property name of the local standard defined electronic card;
storing the Session Initiation Protocol service identification as the parameter of the local standard defined electronic card; and
storing the Session Initiation Protocol Universal Resource Indicator corresponding to the Session Initiation Protocol service as the property value of the local standard defined electronic card.

8. The method for management and interaction of a subscriber identification of a wireless terminal according to claim 1, wherein, the interaction step comprises:
a transmitter transmitting a list of the local standard defined electronic card to a receiver through the exchange technology of the local standard defined electronic card;
the receiver finding the local standard defined electronic card whose property name is the designated identification from the received list of the local standard defined electronic card; and
selecting the property name of the obtained local standard defined electronic card and storing it as the Session Initiation Protocol Universal Resource Indicator.

9. The method for management and interaction of a subscriber identification of a wireless terminal according to claim 1, wherein,
each wireless terminal only has one Session Initiation Protocol Universal Resource Indicator and all the SIP services registered by the wireless terminal use the same Session Initiation Protocol Universal Resource Indicator.

10. The method for management and interaction of a subscriber identification of a wireless terminal according to claim 1, wherein,
each wireless terminal has several Session Initiation Protocol Universal Resource Indicators and each Session Initiation Protocol service registered by the wireless terminal uses a different Session Initiation Protocol Universal Resource Indicator.

11. The method for management and interaction of a subscriber identification of a wireless terminal according to claim 1, wherein,
each wireless terminal has several Session Initiation Protocol Universal Resource Indicators, some Session Initiation Protocol services registered by the wireless terminal use different Session Initiation Protocol Universal Resource Indicators and some Session Initiation Protocol services use the same Session Initiation Protocol Universal Resource Indicator.

12. The method for management and interaction of a subscriber identification of a wireless terminal according to claim 1, wherein,
the interaction of the wireless electronic card between the wireless terminals is carried on the infrared transmission, blue-tooth transmission or wireless phone network transmission; and
the interaction of the wireless electronic card between the wireless terminal and the network side is carried on the packet domain data transmission and/or the circuit domain data transmission.

13. An apparatus for management and interaction of a subscriber identification of a wireless terminal, which is applied in a service based on the Session Initiation Protocol, comprising:
a wireless electronic card function module maintaining a local wireless electronic card list and realizing the interaction of the wireless electronic card with other wireless terminal or with a network side; and
a card generating module connecting with the wireless electronic card function module, and storing the Session Initiation Protocol Universal Resource Indicator in the format of the wireless electronic card in the wireless electronic card list of the wireless electronic card function module.

14. The apparatus for management and interaction of a subscriber identification of a wireless terminal according to claim 13, further comprising:
a card analyzing module connecting with the wireless electronic card function module, and finding the wireless electronic card including the Session Initiation Protocol Universal Resource Indicator from the wireless electronic card information of the other wireless terminals or from the network side received by the wireless electronic card function module and selecting the Session Initiation Protocol Universal Resource Indicator.

15. The apparatus for management and interaction of a subscriber identification of a wireless terminal according to claim 14, further comprising:
a Session Initiation Protocol Universal Resource Indicator management module connecting with the card analyzing module and the card generating module, and storing the Session Initiation Protocol Universal Resource Indicator selected by the card analyzing module.

16. The apparatus for management and interaction of a subscriber identification of a wireless terminal according to claim 14, wherein,
each wireless terminal only has one Session Initiation Protocol Universal Resource Indicator and all the SIP services registered by the wireless terminal use the same Session Initiation Protocol Universal Resource Indicator.

17. The apparatus for management and interaction of a subscriber identification of a wireless terminal according to claim 14, wherein,
each wireless terminal has several Session Initiation Protocol Universal Resource Indicators and each Session Initiation Protocol service registered by the wireless terminal uses a different Session Initiation Protocol Universal Resource Indicator.

18. The apparatus for management and interaction of a subscriber identification of a wireless terminal according to claim 14, wherein,
each wireless terminal has several Session Initiation Protocol Universal Resource Indicators, some Session Initiation Protocol services registered by the wireless terminal use different Session Initiation Protocol Universal Resource Indicators and some Session Initiation Protocol services use the same Session Initiation Protocol Universal Resource Indicator.

19. The apparatus for management and interaction of a subscriber identification of a wireless terminal according to claim 16, wherein,
the interaction of the wireless electronic card between the wireless terminals is carried on the infrared transmission, blue-tooth transmission or wireless phone network transmission; and
the interaction of the wireless electronic card between the wireless terminal and the network side is carried on the packet domain data transmission and/or the circuit domain data transmission.
